(19) United States
(12) Patent Application Publication
(10) Pub. No.: US 2005/0265359 A1
(43) Pub. Date: Dec. 1, 2005

(54) Optimizing switch port assignments

(76) Inventors: Julie Ward Drew, Redwood City, CA (US); Artur Andrzejak, Berlin (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/845,855

(22) Filed: May 13, 2004

(51) Int. Cl. H04L 12/56

(52) U.S. Cl. 370/400

(57) ABSTRACT

An embodiment of a method of designing an interconnect fabric for a set of nodes begins with a step of identifying the set of nodes, a switch, and a set of data flows. The switch comprises a set of ports. The data flows comprise transmissions between the nodes. The method concludes with a step of determining a near optimal assignment of the nodes to the ports of the switch according to a plurality of constraints and an objective.

### FIELD OF THE INVENTION

The present invention relates to the field of networking. More particularly, the present invention relates to the field of networking where a switch couples a plurality of nodes together.

### BACKGROUND OF THE INVENTION

Computer networks take many forms. A LAN (local area network) typically includes computers within a building coupled together by network links. A MAN (metropolitan area network) couples computers together over a region such as a city. A WAN (wide area network) typically includes computer located over a large geographical region which are couple together by network links and routers. Often, LANs are coupled together by a MAN or a WAN. The Internet is an example of a WAN.

A SAN (storage area network) typically forms a secondary network for a LAN. A typical SAN includes hosts and storage devices coupled together by an interconnect fabric. The hosts are typically servers coupled to the LAN or clients which couple to both the LAN and the SAN. The storage devices typically include disk arrays and sometimes include other storage devices such as individual disks or tape drives. Adding a SAN to a LAN can often greatly improve data transfer and storage performance. Since multiple hosts are each capable of accessing the storage devices, bottlenecks which would occur with storage servers or network attached storage in a LAN do not occur with a SAN.

A SAN's interconnect fabric typically includes hub, switches, and links which couple the hosts to the storage devices. Ward et al. in Appia: Automatic storage area network fabric design, Conference on File and Storage Technology, January 2002, teach two methods of automatically designing an interconnect fabric for a SAN, which they refer to as FlowMerge and QuickBuilder. FlowMerge comprises recursively adding layers of interconnect nodes (one or more hubs or one or more switches) between the hosts and storage devices until all flows have been bundled onto links which couple the hosts, the interconnect nodes, and the storage devices. QuickBuilder assigns flows to particular ports pairs where one of the ports is a host port and the other port is a storage device port, divides the port pairs into port groups, and designs an interconnect fabric for each port group. Typically, an interconnect fabric for a port group will include an interconnect node (a hub or a switch) coupled to the hosts and storage devices by links.

Both FlowMerge and QuickBuilder will select a switch as an interconnect node at times. But neither FlowMerge nor QuickBuilder consider which switch ports of the switch should connect to which links of the interconnect fabric. Instead, both FlowMerge and QuickBuilder identify the links that are to connect to the switch. Connecting the links to any of the switch ports will suffice but will not optimize use of the switch. These aspects of FlowMerge and QuickBuilder are not limitations since the goal for these methods is to find an overall interconnect fabric for a SAN. Rather, identification of which switch port should connect to which of a set of links is a separate optimization problem.

SANs typically employ Fibre Channel technology. A number of manufacturers provide various Fibre Channel switches for use in SANs. These switches are available with many port configurations, such as eight port, sixteen port, thirty-two port, sixty-four port, and one-hundred-twenty-eight port switches. Often a port within a small group of ports will transmit data to another port of the group with a low latency. In contrast, the port will transmit data to other ports outside the group with one of a number of longer latencies. For example, the longer latencies may depend upon how many buffers must queue the data as it travels within the switch. Also, available bus bandwidth between ports of the small group may be higher than a bus bandwidth between ports within different groups. These switch characteristics are typical of other network switches as well. Thus, there is a need for a method of determining a near optimal assignment of network links to ports of a switch.

What is needed is a method of designing an interconnect fabric which determines a near optimal assignment of network links to ports of a switch.

### SUMMARY OF THE INVENTION

The present invention comprises a method of designing an interconnect fabric for a set of nodes. According to an embodiment, the method begins with a step of identifying the set of nodes, a switch, and a set of data flows. The switch comprises a set of ports. The data flows comprise transmissions between the nodes. The method concludes with a step of determining a near optimal assignment of the nodes to the ports of the switch according to a plurality of constraints and an objective.

These and other aspects of the present invention are described in more detail herein.

### BRIEF DESCRIPTION OF THE DRAWINGS

The present invention is described with respect to particular exemplary embodiments thereof and reference is accordingly made to the drawings in which:

FIG. 1 illustrates an embodiment of a method of designing an interconnect fabric of the present invention as a flow chart; and

FIG. 2 schematically illustrates an embodiment of a set of nodes and data flows between the nodes for which a method of designing an interconnect fabric of the present invention determines an assignment of nodes to ports of a switch.

### DETAILED DESCRIPTION OF A PREFERRED EMBODIMENT

The present invention comprises a method of designing an interconnect fabric for a set of nodes. According to an embodiment, the method begins with a step of identifying the set of nodes, a switch, and a set of data flows. According to an embodiment, the nodes comprise source nodes and destination nodes. According to another embodiment, the nodes comprise terminal nodes. The switch comprises a set of ports. According to an embodiment, each data flow comprises a transmission from a source node to a destination node. According to another embodiment, each data flow comprises a transmission from a terminal node to another terminal node. The method concludes with a step of determining a near optimal assignment of the nodes to the ports according to constraints and an objective. According to an embodiment, the objective comprises decision variable terms of quadratic order. According to an embodiment in which the objective comprises the decision variables of the quadratic order, the step of determining the near optimal assignment of the nodes to the ports utilizes a local search solution. According to another embodiment, the objective comprises decision variables terms of linear order.

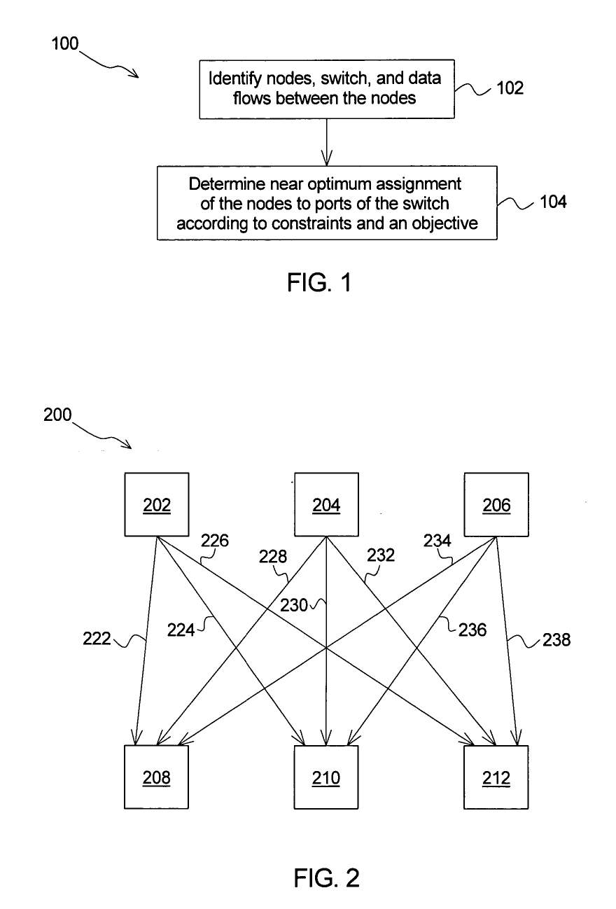

An embodiment of a method of designing an interconnect fabric of the present invention is illustrated as a flow chart in FIG. 1. The method 100 begins with a first step 102 of identifying a set of nodes, a switch, and data flows between the nodes.

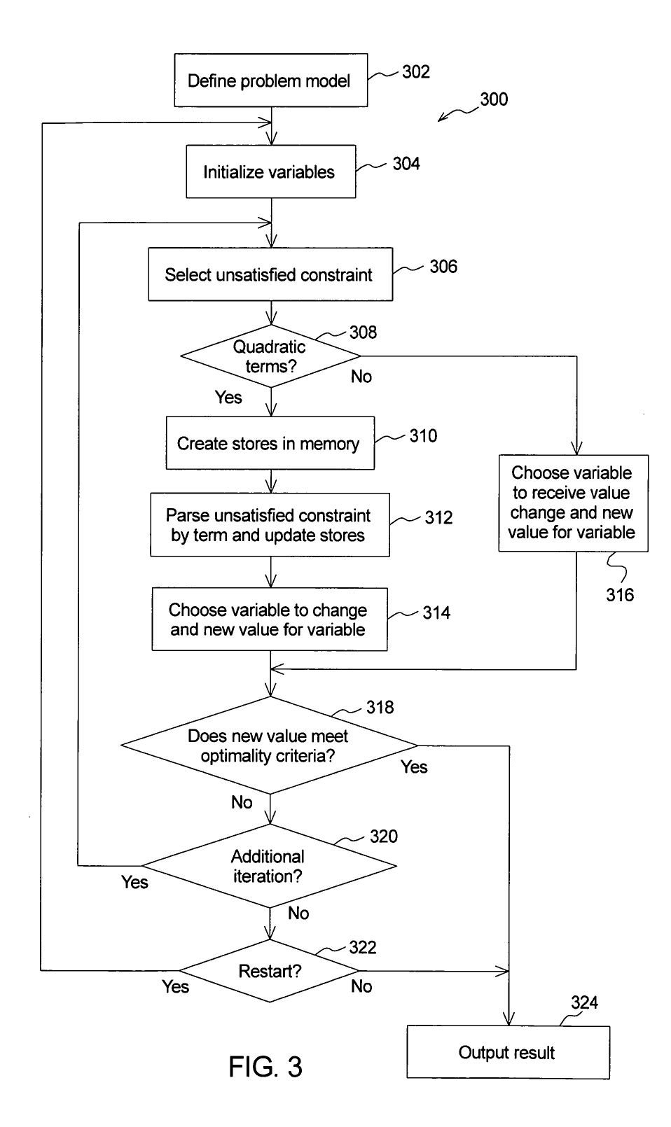

An embodiment of the set of nodes for which the method 100 of the present invention designs an interconnect fabric is schematically illustrated in FIG. 2. The set of nodes 200 comprises first through sixth nodes, 202 . . . 212. The first through third nodes, 202 . . . 206, comprise source nodes. The fourth through sixth nodes, 208 . . . 212, comprise destination nodes. First through third data flows, 222 . . . 226, couple from the first node 202 to the fourth through sixth nodes, 208 . . . 212, respectively. Fourth through sixth data flows, 228 . . . 232, couple from the second node 204 to the fourth through sixth nodes, 208 . . . 212, respectively. Seventh through ninth data flows, 234 . . . 238, couple from the third source node 206 to the fourth through sixth nodes, 208 . . . 212, respectively. Each of the first through ninth data flows, 222 . . . 238, has at least three parameters associated with it. The parameters comprise a source node, a destination node, and a bandwidth.

According to an embodiment, the first through sixth nodes, 202 . . . 212, and the interconnect fabric designed according to the method 100 comprise a SAN (storage area network) or a portion of a SAN. According to an embodiment of the SAN, the first through third nodes, 202 . . . 206, comprise hosts (e.g., servers or clients) and the fourth through sixth nodes, 208 . . . 212, comprise storage devices. According to this embodiment, the first through ninth data flows, 222 . . . 238, depict “writes” on to the storage devices. According to another embodiment of the SAN, one or more of the first through sixth nodes, 202 . . . 212, comprise a hub or switch.

According to an embodiment, the SAN employs a Fibre Channel technology. According to this embodiment, the first through ninth data flows, 222 . . . 238, are routed along bi-directional data transfer paths. According to such an embodiment, designing for “writes” (i.e., data transfers from the hosts to the storage devices) inherently designs for “reads” (i.e., data transfers from the storage devices to the hosts) along return paths. According to another embodiment which does not utilize the bi-directional data transfer paths, the set of nodes 200 comprise terminal nodes and additional data transfers (not shown) would normally exist. Such additional data transfers originate at the fourth through sixth nodes, 208 . . . 212, and terminate at the first through third nodes, 202 . . . 206.

According to another embodiment, the first through sixth nodes, 202 . . . 212, comprise another network such as a LAN (local area network). According to embodiments, the first through sixth nodes, 202 . . . 212, comprise one or more computers (e.g., clients or servers), one or more storage devices, one or more hubs, one or more other switches, one or more other data devices, or a combination thereof.

According to embodiments, the switch comprises an eight port switch. According to other embodiments, the switch comprises a sixteen port switch, a thirty-two port switch, a sixty-four port switch, a one-hundred-twenty-eight port switch, or a switch having another number of ports.

The method 100 concludes with a second step 102 of determining a near optimal assignment of the first through sixth nodes, 202 . . . 212, to ports of the switch according to constraints and an objective (i.e., a mathematical program). The constraints and the objective model the first through sixth nodes, 202 . . . 212, and the switch. According to an embodiment, the constraints and the objective comprise an integer program. According to this embodiment, the objective comprises decision variable terms of quadratic order. According to another embodiment, the constraints and the objective comprise a mixed-integer program. According to this embodiment, the objective comprises decision variables of linear order.

It will be readily apparent to one skilled in the art that mathematical programs (e.g., integer programs and mixed-integer programs) can be formulated in a number of ways. According to a first technique, a mathematical program is formulated according to hard constraints and soft constraints. According to a second technique, a mathematical program is formulated according to a plurality of constraints (the hard constraints of the first technique) and an objective (a summation of the soft constraints of the first technique). Thus, it will be readily apparent to one skilled in the art that within the context of this discussion mention of “constraints” encompasses “hard constraints” and mention of an “objective” encompasses a “soft constraint” or a “summation of soft constraints.”

An embodiment of a mathematical program of the present invention comprises a first integer program. According to an embodiment of the first integer program, the nodes comprise components, which are expressed as components cᵢ where cᵢ ε {c₁, c₂, c₃, . . . cₘ}, the ports of the switch are expressed as ports pⱼ where pⱼ ε {p₁, p₂, p₃, . . . pₙ}, and the data flows are expressed as flows fₖ where fₖ ε {f₁, f₂, f₃, . . . fₛ}. According to an embodiment, each component cᵢ comprises one or more available ports, which are expressed as component ports cpₚ where cpₚ ε {cp₁, cp₂, cp₃, . . . cpₜ}. According to another embodiment, each component cᵢ comprises a single available port.

The first integer program comprises constraints and an objective. According to an embodiment, decision variables for the constraints and the objective are given in Table 1.

TABLE 1

| Decision | Variable | |
|---|---|---|
| variable | type | Description |
| C_to_P(cᵢ, pⱼ) | Boolean | Indicates whether component |
| | | cᵢ couples to port pⱼ |
| F_on_P(fₖ, pⱼ) | Boolean | Indicates whether flow fₖ |
| | | uses port pⱼ |

According to an embodiment, input values for the constraints and the objective are given in Table 2.

TABLE 2

| | Value | |
|---|---|---|
| Input value | type | Description |
| Bndwdth(fₖ) | Scalar | Bandwidth for data flow fₖ |
| P_Bndwdth(pⱼ) | Scalar | Bandwidth for port pⱼ |
| P_Dist(pⱼ, p_{β}) | Scalar | Distance from port pⱼ to port p_{β} |
| Src(fₖ) | Object | Component cᵢ which is source of |
| | | flow fₖ |
| Dest(fₖ) | Object | Component cᵢ which is destination |
| | | for flow fₖ |

The input value P_Dist(pⱼ, p_{β}) models a switch according to a distance that a flow travels from port pⱼ to port p₆₂ within the switch. Such distances reflect the times (or latencies) that flows take to traverse the switch. Such “distances” or “times” will vary according to the internal architecture of the switch.

The first integer program comprises port bandwidth constraints. The port bandwidth constraints comprise limiting the data flow for each port to a port bandwidth. An embodiment of the port bandwidth constraints comprise:

$${\sum }_{k} F\_on \_P ( {f}_{k} , {p}_{j} ) Bndwdth ( {f}_{k} ) \leq P\_Bndwdth ( {p}_{j} ) ∀ j$$

The first integer program further comprises flow conservation constraints. The flow conservation constraints comprise assigning each data flow to two of the ports (i.e., a flow must enter and exit the switch). An embodiment of the flow conservation constraints comprise:

$${\sum }_{j} F\_on \_P ( {f}_{k} , {p}_{j} ) = 2 ∀ k$$

The first integer program further comprises switch port assignment constraints. The switch port assignment constraints comprise limiting an assignment of nodes to each port to a single node (i.e., only one node can be assigned to a particular port of the switch). An embodiment of the switch port assignment constraints comprise:

$${\sum }_{i} C\_to \_P ( {c}_{i} , {p}_{j} ) \leq 1 \qquad ∀ j$$

The first integer program further comprises flow assignment constraints. The flow assignment constraints ensure that each component cᵢ that is a source or destination for a data flow fₖ is coupled to a switch port pⱼ. An embodiment of the flow assignment constraints comprise:

$$\begin{matrix}{\sum }_{j} C\_to \_P [ Src ( {f}_{k} ) , {p}_{j} ] = 1 & ∀ k \\ {\sum }_{j} C\_to \_P [ Dest ( {f}_{k} ) , {p}_{j} ] = 1 & ∀ k\end{matrix}$$

The first integer program further comprises flow-component constraints. The flow-component constraints ensure that each flow that enters or exits a switch port corresponds to a component coupled to the port that is a source or destination of the flow, respectively. An embodiment of the flow-component constraints comprise:
F_on_{—}P(fₖ, pⱼ)=C_to_{—}P[Sourc(fₖ), pⱼ]+C_to_{—}P[Dest(fₖ), pⱼ]∀k,j

According to an embodiment in which some of the components cᵢ comprise multiple component ports cpₚ, the first integer program further comprises node assignment constraints. The node assignment constraints ensure that a component cᵢ can only connect to as many switch ports pⱼ as it has component ports cpₚ where p ε {1, 2, . . . t}. An embodiment of the node assignment constraints comprise:

$${\sum }_{j} C\_to \_P ( {c}_{i} , {p}_{j} ) \leq t \qquad ∀ i$$

According to an embodiment of the first integer program, the objective comprises seeking a near minimum for a summation of distances that flows travels within the switch with each distance weighted by the bandwidth of its flow. An embodiment of the objective comprises:

$$min {\sum }_{j} {\sum }_{β > j} {\sum }_{k} F\_on \_P ( {f}_{k} , {p}_{j} ) F\_on \_P ( {f}_{k} , {p}_{β} ) P\_Dist ( {p}_{j} , {p}_{β} ) Bndwdth ( {f}_{k} )$$

According to this embodiment of the objective, the objective comprises quadratic terms of F_on_P(fₖ, pⱼ)F_on_P(fₖ, p_{β}).

According to another embodiment of the first integer program, the objective comprises seeking a minimum for a summation of latencies that flows experience when traveling within the switch with each latency weighted by the bandwidth of its flow.

An embodiment of a method of solving an integer program which includes an objective that comprises quadratic terms is illustrated as a flow chart in FIG. 3. The method 300 comprises a local search solution in which a gradient following approach iteratively improves an initial assignment of values to the variables until a near optimal solution is reached. Each iteration of the local search solution produces a new assignment of values for the variables. The new assignment of values differs from a previous assignment of values by one value for a particular variable.

The method 300 begins with a first step 302 of defining a problem model for an over-constrained integer programming problem. The problem model comprises data, variables, and constraints. According to an embodiment, the data comprises the components cᵢ, the ports of switch pⱼ, the data flows fₖ, the component ports cpₚ, and the input values listed in Table 2. The variables comprise the decision variables C_to_P(cᵢ, pⱼ) and F_on_P(fₖ, pⱼ), which are Boolean variables. In the over-constrained integer programming problem, the constraints comprise hard constraints and at least one soft constraint. According to an embodiment, the hard constraints comprise the port bandwidth constraint, the flow conservation constraint, the switch port assignment constraint, the node assignment constraint, and the node-flow constraint. According to another embodiment, the hard constraints further comprise the bus bandwidth constraint. The soft constraint is the objective, which comprises a summation of a distance that each flow travels within the switch weighted by the bandwidth of the flow.

In a second step 304, the decision variables are initialized. According to an embodiment, the decision variables are initialized randomly. According to another embodiment, the decision variables are initialized with values which meet the hard constraints while disregarding the soft constraint. A third step 306 selects an unsatisfied constraint. In the embodiment in which the decision variables are initialized with values that meet the hard constraints, the unsatisfied constraint will be the soft constraint (i.e., the objective).

In a fourth step 308, the method determines whether the unsatisfied constraint includes quadratic terms. According to the present invention, the hard constraints have linear terms and the soft constraint has quadratic terms. So in the context of the present invention, if the fourth step 308 determines that the unsatisfied constraint has quadratic terms, the unsatisfied constraint is the soft constraint. If the unsatisfied constraint has the quadratic terms, the method 300 creates stores in memory for each of the decision variables in the soft constraint in a fifth step 310. In a sixth step 312, the method 300 parses the unsatisfied constraint by term. For each of the decision variables in the term, an associated store is updated with a change in the unsatisfied constraint due to flipping the value of the decision variable while holding other decision variables constant. In a seventh step 314, the decision variable that is to have its value flipped is chosen according to an improvement criterion, such as the decision variable which most improves the unsatisfied constraint or the decision variable which most improves an overall solution while also improving the unsatisfied constraint.

If the fourth step 308 determines that the unsatisfied constraint does not include the quadratic or higher order terms, an eighth step 316 chooses the decision variable that is to have it value flipped according to a linear coefficient for a term and an improvement criteria, such as the decision variable which most improves the unsatisfied constraint or the decision variable which most improves an overall solution while also improving the unsatisfied constraint.

In a ninth step 318, the method 300 compares assigned values to optimality criteria to determine whether a solution has been found. The optimality criteria for the over-constrained integer programming problem are no violation of the hard constraints and a near optimal solution for the soft constraint. If the optimality criteria are not met, the method 300 continues in a tenth step 320 with a determination of whether an additional iteration is to be performed. If so, the method 300 returns to the third step 306 of selecting another unsatisfied constraint to determine another placement variable which is to have its value flipped. If not, an eleventh step 322 determines whether to restart the method 300 by reinitializing the variables. If the optimality criteria are met in the ninth step 318, a final value assignment for the placement variables is output as a result in the twelfth step 324. If the eleventh step 322 determines to not restart the method 300, a “no solution found” message is output in the twelfth step 324.

According to an embodiment, the method 300 is implemented using AMPL, a modeling language for optimization problems. According to another embodiment, the method 700 is implemented using an alternative modeling language.

Other embodiments of local search solutions for over-constrained integer programming problems which include quadratic or higher order terms are taught in U.S. patent application Ser. No. 10/627,724, filed on Jul. 25, 2003, and entitled Determination of one or more variables to receive value changes in local search solution of integer programming problem, which is hereby incorporated by reference in its entirety.

According to an alternative embodiment of the first integer program, the constraints further comprise a bus bandwidth constraint. According to an embodiment, an additional input value comprises a bus bandwidth Bus_Bandwidth(P, Q) between sets of switch ports, P and Q. According to an embodiment, the bus bandwidth constraint comprises:

$${\sum }_{{p}_{j} ∈ P} {\sum }_{{p}_{β} ∈ Q} {\sum }_{k} F\_on \_P ( {f}_{k} , {p}_{j} ) F\_on \_P ( {f}_{k} , {p}_{β} ) Bndwdth ( {f}_{k} ) \leq Bus\_Bandwidth ( P , Q )$$

for all sets of ports P, Q such that P∩Q=Ø.

According to another alternative embodiment of the first integer program, the constraints do not include the port bandwidth constraints.

According to another embodiment, the mathematical program of the present invention comprises a first mixed integer program. The first mixed integer program adds an additional decision variable. The additional decision variable replaces the quadratic term in the objective. According to an embodiment, the additional decision variable comprises a continuous variable with values within the range [0, 1]. According to this embodiment, the additional decision variable takes binary values (i.e., 0 or 1) when the mixed integer program is solved.

According to an embodiment of the first mixed integer program, the nodes comprise components, which are expressed as components cᵢ where cᵢ ε {c₁, c₂, c₃, . . . cₘ}, the ports of the switch are expressed as ports pⱼ where pⱼ ε {p₁, p₂, p₃, . . . pₙ}, and the data flows are expressed as flows fₖ where fₖ ε {f₁, f₂, f₃, . . . fₛ}. According to an embodiment, each component cᵢ comprises one or more available ports, which are expressed as component ports cpₚ where cpₚ ε {cp₁, cp₂, cp₃, . . . cpₜ}. According to another embodiment, each component cᵢ comprises a single available port.

The first mixed integer program comprises constraints and an objective. According to an embodiment, decision variables for the constraints and the objective are given in Table 3.

TABLE 3

| | Variable | |
|---|---|---|
| Decision variable | type | Description |
| C_to_P(cᵢ, pⱼ) | Boolean | Indicates whether cᵢ couples |
| | | to port pⱼ |
| F_on_P(fₖ, pⱼ) | Boolean | Indicates whether flow fₖ |
| | | uses port pⱼ |
| F_on_P_Pr(fₖ, p_{β}) | Continuous | Indicates whether flow fₖ |
| | | uses ports pⱼ and p_{β} |

According to an embodiment, input values for the constraints and the objective are given in Table 2 above.

According to an embodiment of the first mixed integer program, the constraints comprise the port bandwidth constraints, the flow conservation constraints, the switch port assignment constraints, the flow assignment constraints, and the flow-component constraints of the first integer program.

The first mixed integer program further comprises a switch port pair assignment constraint. According to an embodiment, the switch port pair assignment constraint ensures that a flow is assigned to one and only one pair of switch ports. An embodiment of the switch port pair assignment constraints comprise:

$${\sum }_{β > j} {\sum }_{j} F\_on \_P \_Pr ( {f}_{k} , {p}_{j} , {p}_{β} ) = 1 ∀ k$$

The first mixed integer program further comprises additional constraints which in combination with the objective force a flow on port pair decision variable F_on_P_Pr(fₖ, p_{β}) (i.e., the additional decision variable) to take binary values. Embodiments of the additional constraints comprise:
F_on_{—}P_{—}Pr(fₖ, pⱼ, p_{β})≧F_on_{—}P(fₖ, pⱼ)+F_on_{—}P(fₖ, p_{β})−1
F_on_{—}P_{—}Pr(fₖ, pⱼ, p_{β})≧0
F_on_{—}P_{—}Pr(fₖ, pⱼ, p_{β})≦1
∀k, j, β

According to an embodiment, the objective for the first mixed integer program comprises seeking a near minimum for a summation of distances that flows travel within the switch with each distance weighted by the bandwidth of its flow. An embodiment of the objective comprises:

$$min {\sum }_{j} {\sum }_{β > j} {\sum }_{k} F\_on \_P \_Pr ( {f}_{k} , {p}_{j} , {p}_{β} ) P\_Dist ( {p}_{j} , {p}_{β} ) Bndwdth ( {f}_{k} )$$

According to this embodiment of the objective, the objective comprises linear terms of F_on_P_Pr(fₖ, pⱼ, p_{β}). Accordingly, a readily available commercial solver may be employed to solve the mixed integer program.

According to an alternative embodiment of the first mixed integer program, the constraints do not include the port bandwidth constraints. According to another alternative embodiment of the first mixed integer program, the constraints further comprise bus bandwidth constraints.

Another embodiment of a mathematical program of the present invention comprises a second integer program. According to an embodiment of the second integer program, the nodes are expressed as source nodes nₛ where nₛ ε {n₁, n₂, n₃, . . . nₙ} and destination nodes n_{d} ε {n₁, n₂, n₃, . . . nₘ}, the ports of the switch are expressed as ports pⱼ where pⱼ ε {p₁, p₂, p₃, . . . p_{q}}, and the data flows are expressed as flows f_{sd} where f_{sd} ε {f₁₁, f₁₂, . . . f₂₁, f₂₂, . . . fₙₘ}. According to an embodiment, the source nodes nₛ comprise hosts and the destination nodes n_{d} comprise storage devices. According to an embodiment, multi-port hosts are modeled as multiple source nodes and multi-port storage devices are modeled as multiple destination node.

The second integer program comprises constraints and an objective. According to an embodiment, decision variables for the constraints and the objective are given in Table 4.

TABLE 4

| Dec. | Variable | |
|---|---|---|
| variable | type | Description |
| Xₛⱼ | Boolean | Indicates whether source node nₛ couples |
| | | to port pⱼ |
| X_{dj} | Boolean | Indicates whether dest. node n_{d} couples |
| | | to port pⱼ |

According to an embodiment, input values for the constraints and the objective are given in Table 5.

TABLE 5

| Input | Value | |
|---|---|---|
| value | type | Description |
| B_{sd} | Scalar | Flow bandwidth from node nₛ to node n_{d} |
| PBⱼ, | Scalar | Bandwidth for port pⱼ |
| PD_{jg} | Scalar | Distance from port pⱼ to port p_{g} |

The second integer program comprises port bandwidth constraints, which comprise limiting the data flow for each input port and each output port to a port bandwidth. According to an embodiment, the port bandwidth constraints comprise:

$${\sum }_{s} {\sum }_{d} {X}_{sj} {B}_{sd} + {\sum }_{s} {\sum }_{d} {X}_{dj} {B}_{sd} \leq {PB}_{j} \qquad ∀ j$$

The second integer program further comprises node assignment constraints, which ensure that each source node nₛ is assigned to an input port pⱼ and which ensure that each destination node n_{d} is assigned to an output port p_{g}. According to an embodiment, the node assignment constraints comprise:

$${\sum }_{j} {X}_{sj} = 1 ∀ s$$

$${\sum }_{j} {X}_{dj} = 1 ∀ d$$

According to an embodiment for the case of bi-directional ports (e.g., Fibre channel ports in a SAN switch), the second integer program further comprises an additional node assignment constraint. The additional node assignment constraint ensures that a port can only be assigned as an input port or an output port. According to an embodiment, the additional node assignment constraints comprise:

$${\sum }_{s} {X}_{sj} + {\sum }_{d} {X}_{dj} \leq 1 ∀ j$$

According to an embodiment of the second integer program, the objective comprises minimizing a summation of distances that flows travel within the switch with each distance weighted by the bandwidth of its flow. According to an embodiment, the objective comprises:

$$min {\sum }_{d} {\sum }_{s} {\sum }_{g \neq j} {\sum }_{j} {X}_{sj} {X}_{dg} {PD}_{jg} {B}_{sd}$$

According to this embodiment of the objective, the objective comprises quadratic terms of XₛⱼX_{dg}. Accordingly, a method of solving the integer program comprises the method 300 (FIG. 3) discussed above.

According to an alternative embodiment of the second integer program, the constraints further comprise a bus bandwidth constraint. According to another alternative embodiment of the second integer program, the constraints do not include the port bandwidth constraints.

Depending upon a particular set of nodes and data flows, either the first or second integer program might more efficiently determine a near optimal solution. This can be understood by recognizing that the first integer program seeks a near optimal solution based on individual flows while the second integer program seeks a near optimal solution by connecting nodes to switch ports.

If each node has only a few flows associated with it (e.g., between one and three flows), the first integer program more is expected to lead to a more efficiently determined solution since the first integer program will have much fewer decision variables than the second integer program and it is reasonable to expect to achieve a near optimal solution for a small group of flows by deciding to move the flows based upon one of the flows. For example, if a node is a destination for three flows having relative bandwidths of 50%, 30%, and 20%, it is reasonable to expect that moving the three flows from a first port to a second port based on one of the flows will improve the solution.

On the other hand, if each node has many flows associated with it, the number of variables for the first integer program approaches the number of variables for the second integer program and it becomes much less reasonable to expect that deciding to move a large group of flows based upon a single flow within the group will improve a solution. For example, if a source node has twenty-four flows associated with it and none of the flows has a relative bandwidth of more than 10%, a decision to move the twenty-four flows based upon one of the flows is not likely to follow a gradient to a near optimal solution. In contrast, the second integer program deals with all flows associated with a node since the decision variable reflects a coupling of a node to a port. Thus, if each node has many flows, the second integer program is expected to more efficiently determine a near optimal solution.

Another embodiment of a mathematical program of the present invention comprises a second mixed integer program. The second mixed integer program replaces the quadratic terms of the objective for the second integer program (i.e., XₛⱼX_{dg}) with a new decision variable (e.g., Y_{sjdg}). According to an embodiment, a formulation of the second mixed integer program is similar to the first mixed integer program except that while the first mixed integer program comprises a linearization of the first integer program the second mixed integer program comprises a linearization of the second integer program.

The mathematical programs of the present invention are NP-hard. The term “NP-hard” means that an exact solution can only be obtained within a feasible time period for a small problem size. Providing more computing power only slightly increases the problem size for which one can expect to find the exact solution. Accordingly, when solving the mathematical programs of the present invention, a solver seeks a near optimal solution rather than an optimal solution. However, nothing prevents the solver from actually selecting the optimal solution. Accordingly, within the context of the present invention the term “near optimal solution” also encompasses the optimal solution.

The foregoing detailed description of the present invention is provided for the purposes of illustration and is not intended to be exhaustive or to limit the invention to the embodiments disclosed. Accordingly, the scope of the present invention is defined by the appended claims.

1. A method of designing an interconnect fabric for a set of nodes comprising the steps of:
identifying the set of nodes, a switch, and a set of data flows, the switch comprising a set of ports, the data flows comprising transmissions between the nodes; and
determining a near optimal assignment of the nodes to the ports of the switch according to a plurality of constraints and an objective.

2. The method of claim 1 wherein the step of determining the near optimal assignment of the nodes to the ports of the switch determines an optimal assignment.

3. The method of claim 1 wherein the nodes comprise one or more computers, one or more storage devices, one or more other switches, one or more other data devices, or a combination thereof.

4. The method of claim 1 wherein the switch comprises at least eight of the ports.

5. The method of claim 1 wherein the switch comprises at least sixteen of the ports.

6. The method of claim 1 wherein the switch comprises at least thirty-two of the ports.

7. The method of claim 1 wherein the switch comprises at least sixty-four of the ports.

8. The method of claim 1 wherein a particular data flow begins at a source node and ends at a destination node.

9. The method of claim 8 wherein the particular data flow arrives at the source node from another node and further wherein the source node couples the other node to the switch.

10. The method of claim 8 wherein the destination node transmits the particular data flow to another node and further wherein the destination node couples the other node to the switch.

11. The method of claim 8 wherein another data flow begins at the source node and ends at another destination node.

12. The method of claim 1 wherein the constraints comprise:
assigning each data flow to two of the ports;
limiting an assignment of nodes to each port to a single node; and
ensuring that the data flows between a particular node and a particular port correspond to the assignment of the particular node to the particular port.

13. The method of claim 12 wherein the constraints further comprise limiting the data flow for each port to a port bandwidth.

14. The method of claim 12 wherein the constraints further comprise ensuring that internal data flows within the switch do not exceed internal bus bandwidths.

15. The method of claim 1 wherein the constraints comprise:
ensuring that each node is assigned to a port; and
limiting an assignment of nodes to each port to a single node.

16. The method of claim 15 wherein the constraints further comprise limiting the data flow for each port to a port bandwidth.

17. The method of claim 15 wherein the constraints further comprise ensuring that internal data flows within the switch do not exceed internal bus bandwidths.

18. The method of claim 1 wherein the objective comprises minimizing a sum of weighted transmission times for the data flows.

19. The method of claim 1 wherein the objective comprises minimizing a sum of weighted transmission distances for the data flows.

20. The method of claim 1 wherein the objective comprises decision variable terms of at least quadratic order.

21. The method of claim 20 wherein the step of determining the near optimal assignment of the nodes to the ports of the switch employs a local search solution technique.

22. The method of claim 21 wherein the local search solution technique comprises:
selecting an unsatisfied constraint or the objective;
if the objective has been selected:
creating a store in memory for each decision variable in the objective;
parsing the objective by term; and
for each decision variable in the term, updating an associated store with a change to the objective while holding other decision variables constant; and
selecting the decision variable which is to receive a value change according to an improvement criterion.

23. The method of claim 1 wherein the objective comprises a linear function of decision variables.

24. A method of designing an interconnect fabric for a set of nodes comprising the steps of:
identifying the set of nodes, a switch, and a set of data flows, the switch comprising a set of ports, the data flows comprising transmissions between the nodes; and
determining a near optimal assignment of the nodes to the ports of the switch using a local search solution of an integer program comprising a plurality of constraints and an objective, the objective comprising decision variable terms of at least quadratic order.

25. The method of claim 24 wherein the step of determining the near optimal assignment of the nodes to the ports of the switch determines an optimal assignment.

26. The method of claim 24 wherein the constraints comprise:
assigning each data flow to two of the ports;
limiting an assignment of nodes to each port to a single node; and
ensuring that the data flows between a particular node and a particular port correspond to the assignment of the particular node to the particular port.

27. The method of claim 24 wherein the constraints comprise:
ensuring that each node is assigned to a port; and
limiting an assignment of nodes to each port to a single node.

28. The method of claim 24 wherein the objective comprises minimizing a sum of weighted transmission times for the data flows.

29. The method of claim 24 wherein the objective comprises minimizing a sum of weighted transmission distances for the data flows.

30. A method of designing an interconnect fabric for a set of nodes comprising the steps of:
identifying the set of nodes, a switch, and a set of data flows, the switch comprising a set of ports, the data flows comprising transmissions between the nodes; and
determining a near optimal assignment of the nodes to the ports of the switch according to:
a plurality of constraints comprising:
limiting the data flow for each port to a port bandwidth;
assigning each data flow to two of the ports;
limiting an assignment of nodes to each port to a single node; and
ensuring that the data flows between a particular node and a particular port correspond to the assignment of the particular node to the particular port; and
an objective of minimizing a sum of weighted transmission times for the data flows.

31. The method of claim 30 wherein the step of determining the near optimal assignment of the nodes to the ports of the switch determines an optimal assignment.

32. The method of claim 30 wherein the objective comprises decision variable terms of at least quadratic order.

33. The method of claim 32 wherein the step of determining the near optimal assignment of the nodes to the ports of the switch employs a local search solution technique.

34. The method of claim 33 wherein the local search solution technique comprises:
selecting an unsatisfied constraint or the objective;
if the objective has been selected:
creating a store in memory for each decision variable in the objective;
parsing the objective by term; and
for each decision variable in the term, updating an associated store with a change to the objective while holding other decision variables constant; and
selecting the decision variable which is to receive a value change according to an improvement criterion.

35. A computer readable memory comprising computer code for implementing a method of designing an interconnect fabric for a set of nodes, the method of designing the interconnect fabric comprising the steps of:
identifying the set of nodes, a switch, and a set of data flows, the switch comprising a set of ports, the data flows comprising transmissions between the nodes; and
determining a near optimal assignment of the nodes to the ports of the switch according to a plurality of constraints and an objective.

36. The computer readable memory of claim 35 wherein the step of determining the near optimal assignment of the nodes to the ports of the switch determines an optimal assignment.

37. A computer readable memory comprising computer code for implementing a method of designing an interconnect fabric for a set of nodes, the method of designing the interconnect fabric comprising the steps of:
identifying the set of nodes, a switch, and a set of data flows, the switch comprising a set of ports, the data flows comprising transmissions between the nodes; and
determining a near optimal assignment of the nodes to the ports of the switch using a local search solution of an integer program comprising a plurality of constraints and an objective, the objective comprising decision variable terms of at least quadratic order.

38. The computer readable memory of claim 37 wherein the step of determining the near optimal assignment of the nodes to the ports of the switch determines an optimal assignment.

39. A computer readable memory comprising computer code for implementing a method of designing an interconnect fabric for a set of nodes, the method of designing the interconnect fabric comprising the steps of:
identifying the set of nodes, a switch, and a set of data flows, the switch comprising a set of ports, the data flows comprising transmissions between the nodes; and
determining a near optimal assignment of the nodes to the ports of the switch according to:
a plurality of constraints comprising:
limiting the data flow for each port to a port bandwidth;
assigning each data flow to two of the ports;
limiting an assignment of nodes to each port to a single node; and
ensuring that the data flows between a particular node and a particular port correspond to the assignment of the particular node to the particular port; and
an objective of minimizing a sum of weighted transmission times for the data flows.

40. The computer readable memory of claim 39 wherein the step of determining the near optimal assignment of the nodes to the ports of the switch determines an optimal assignment.

41. The computer readable memory of claim 39 wherein the objective comprises decision variable terms of at least quadratic order.

42. The computer readable memory of claim 41 wherein the step of determining the near optimal assignment of the nodes to the ports of the switch employs a local search solution technique.

43. The method of claim 42 wherein the local search solution technique comprises:
selecting an unsatisfied constraint or the objective;
if the objective has been selected:
creating a store in memory for each decision variable in the objective;
parsing the objective by term; and
for each decision variable in the term, updating an associated store with a change to the objective while holding other decision variables constant; and
selecting the decision variable which is to receive a value change according to an improvement criterion.
